(19) United States
(12) Patent Application Publication
(10) Pub. No.: US 2003/0011813 A1
(43) Pub. Date: Jan. 16, 2003

(54) Computing system with print job retention

(76) Inventors: Gary M. Peter, Boise, ID (US); Matt Howell, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/907,095

(22) Filed: Jul. 16, 2001

(51) Int. Cl. B41J 1/00; G06F 15/00; B41F 1/00

(52) U.S. Cl. 358/1.15; 358/1.14; 358/1.1

(57) ABSTRACT

A computing system including a first computer, a remote computer and a printer. The first computer is operable by a user to transmit a print job to the printer. The first computer is configured to automatically transmit a message to the remote computer. The message includes a copy of the print job. The remote computer is responsive to the message by storing the copy of the print job and by storing a record of the copy of the print job. A user can operate the first computer to retrieve and display this record. The user can also operate the first computer to cause the remote computer to transmit the copy of the print job to second printer.

### BACKGROUND OF THE INVENTION

Today, some printers are able to locally retain print jobs indefinitely for future printing. Such printers may be referred to as supporting “job retention printing”. A printer that supports job retention printing is described in the patent entitled “MULTIPLE COPY PRINTER WITH PRINT JOB RETENTION”, having U.S. Pat. No. 6,160,629. That patent is incorporated herein by reference.

There are several types of retention printing. One type of retention printing is commonly referred to as “quick copy printing”. According to quick copy printing, a printer stores a received multi-copy print job and prints the copies. Thereafter, a walk-up user can cause additional copies to be printed by interacting with the printer's control panel.

A second type of retention printing is commonly referred to as “Proof and Hold” printing. According to “Proof and Hold” printing, a printer stores a received multi-copy print job and prints a limited number of copies (typically one copy). Thereafter, a walk-up user can cause the rest of the copies to be printed via the printer's control panel.

A third type of retention printing is commonly referred to as “private” printing. According to private printing, a printer stores a received print job and delays printing until a privacy code is entered by a walk-up user at the printer's control panel.

A fourth type of retention printing is commonly referred to as “simple retention” printing. According to simple retention printing, a printer stores a received print job and does not immediately print it. Future printing of the job is then available to walk up users via the printer's control panel.

Printers that support job retention printing can provide a user with a number of benefits. For example, such printers can eliminate the need to convert a document into a print job each time a document is re-printed. Additionally, because job retention printing can provide multiple prints of a document from the same print job, the user can be assured that the same version of a document is produced each time it is printed.

Unfortunately, not all printers support retention printing. This can represent a significant problem to a user who wishes to take advantage of the benefits associated with retention printing.

### SUMMARY OF THE INVENTION

The invention may be implemented, for example, as a method of storing a copy of a print job. The method may include transmitting a print job to a first printer; and automatically transmitting a message to a retention system. The message includes a copy of the print job. The retention system is responsive to the message by storing the print job copy.

The invention may also be implemented, for example, as a computer readable medium embodying a program of instructions executable by the computer to perform method steps. The method steps may include transmitting a print job to a printer; and automatically causing a remote computing device to store a copy of the print job.

The invention may also be implemented, for example, as a system. The system, may include, for example, a retention system; and a first computer operable by a user to transmit a print job to a printer and configured to automatically transmit a message to the retention system. The message includes a copy of the print job. The retention system is responsive to receiving the message by storing the copy of the print job.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a computing system including a personal computer and a retention system;

FIG. 2 is a flow diagram illustrating the operation of the personal computer;

FIG. 3 illustrates the operation of the retention system;

FIG. 4 is a flow diagram illustrating further the operation of the personal computer;

FIG. 5 is a flow diagram illustrating further the operation of the retention system;

FIG. 6 is a flow diagram illustrating further the operation of the personal computer; and

FIG. 7 is a flow diagram illustrating further the operation of the retention system.

### DETAILED DESCRIPTION OF THE INVENTION

For purposes of this application, a print job that invokes one of the four types of retention printing described above may generally be referred to herein as a “retention job”. Thus, for example, a print job that invokes “quick copy printing” may be referred to herein as a “retention job”. A printer that can perform retention printing may be referred to herein as a “retention” printer. A printer that does not support job retention printing may be referred to herein as a “non-retention” printer.

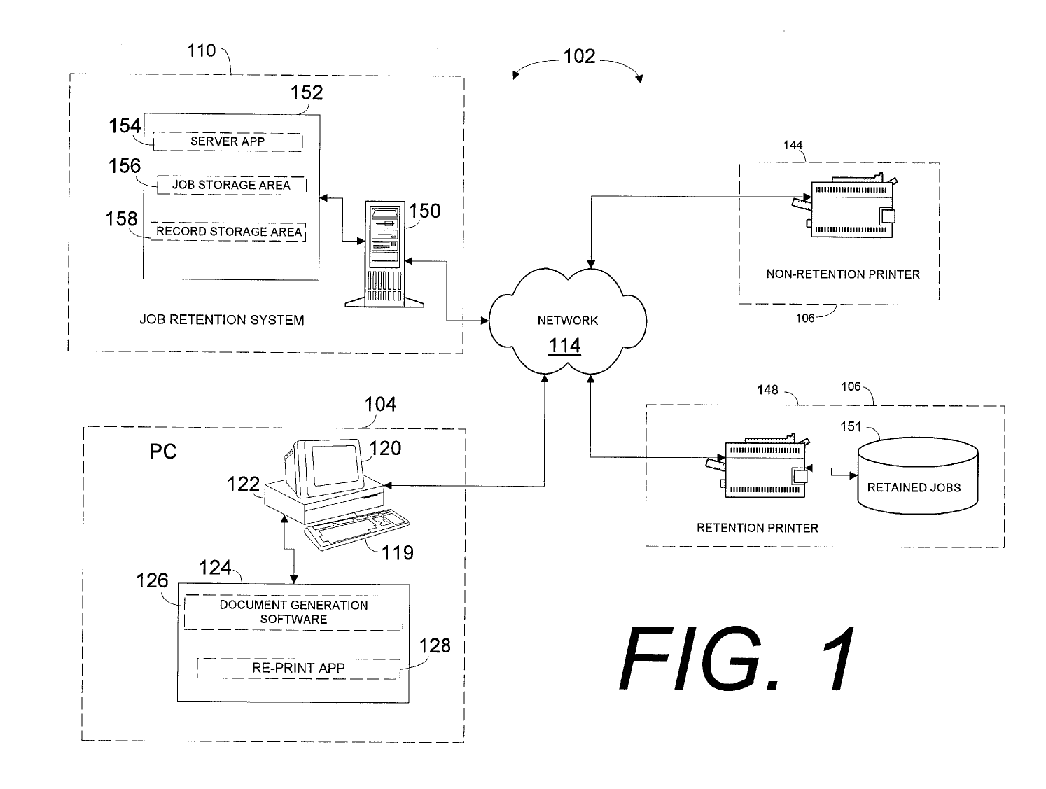

FIG. 1 shows a novel computing system 102 incorporating an embodiment of the invention. The computing system 102 includes a personal computer (PC) 104, a group of printers 106 and a job retention system 110 all communicatively coupled to a network 114. The network 114 may represent, for example, an Intranet or the INTERNET or some combination thereof.

In this example, the group of printers 106 include a non-retention printer 144 and a retention printer 148. The retention printer 148 includes a local disk drive 151. The local disk drive 151 is used to locally retain retention jobs. Each printer in the group of printers 106 is assigned a unique printer Identifier (ID).

The PC 104 includes a processing unit 122, a memory 124 and a user interface. The user interface includes a keyboard 119 and a display monitor 120. Stored in the memory 124 is “document generation software” 126 and a “re-print application” 128. The processing unit 122 can retrieve and execute all of this software in an appropriate manner. A user can provide input to the executing software via the keyboard 119. The software can display information to a user via the display monitor 120.

In general, the document generation software 126 allows a user to print documents by transmitting print jobs to the non-retention printer 144 or the retention printer 148. The document generation software 126 may represent, for example, a word processing application and/or one or more print drivers.

As shown, the retention system 110 includes a processing unit 150 and a memory 152. The memory 152 includes a server application 154. The processing unit 150 can retrieve and execute this application in an appropriate manner. Additionally, the memory 152 includes a first reserved area (job storage area) 156 and a second reserved area (record storage area) 158.

As will be discussed in greater detail below, the job storage area 156 is used to retain copies of certain print jobs that are transmitted from the PC 104 to the non-retention printer 144. The record storage area 158 is used to maintain a record (job record) of each print job that is presently stored in the job storage area 156. In addition, the record storage area 158 is used to maintain a job record of certain jobs that are presently being retained by the retention printer 148.

Printing to the Non-retention Printer (Operational Scenario #2)

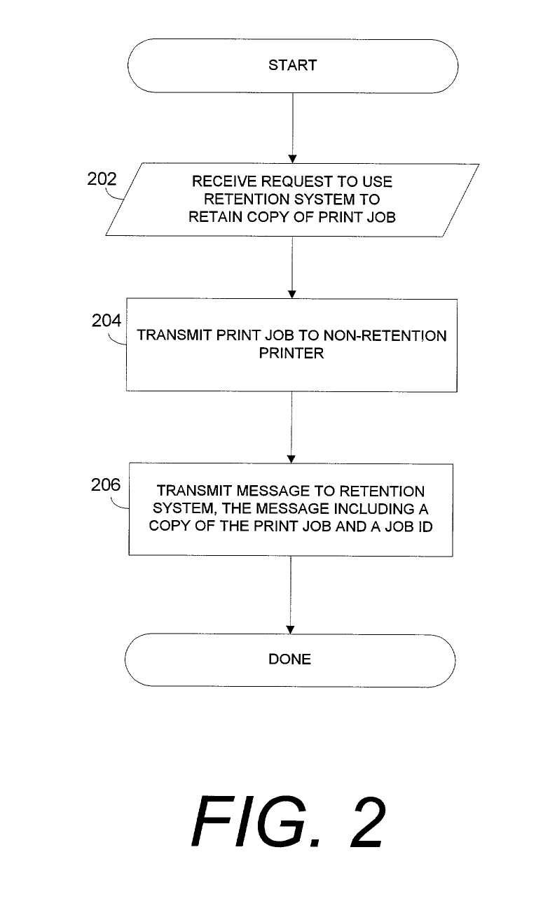

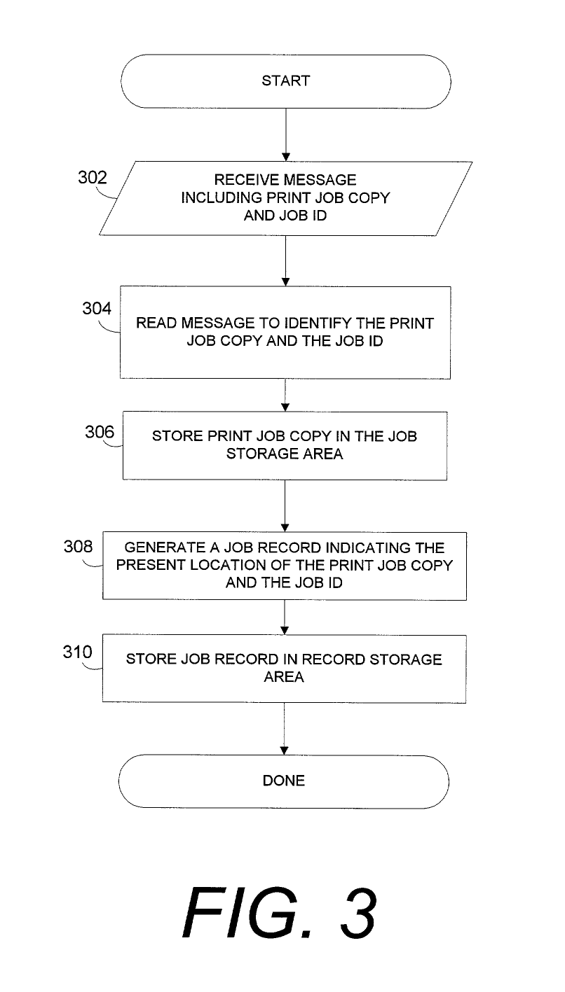

In general, a user of the PC 104 can make use of the retention system 110 to retain copies of print jobs that are transmitted from the PC 104 to the non-retention printer 144. FIG. 2 and FIG. 3 illustrate this functionality.

FIG. 2 is a flow diagram illustrating the operation of the PC 104, under the direction of the document generation software 126, to transmit a print job assuming the following two conditions exist. First, the print job is being transmitted to the non-retention printer 144. Secondly, the user enters a request to retain a copy of the print job.

Turning now to FIG. 2, the PC 104 receives the request from the user to use the retention system to retain a copy of the print job (block 202). Next, the PC 104 automatically transmits the print job to the non-retention printer 144 (block 204).

In response to the request received at block 202, the PC 104 transmits a first message to the retention system 110 (block 206). The first message includes a copy of the print job and a unique job ID. The Job ID is assigned to the print job.

FIG. 3 illustrates the operation of the retention system 110, under the direction of the server application 154, upon receiving the first message from the PC 104. Turning now to FIG. 3, the retention system 110 receives the first message at block 302.

Next, the retention system 110 reads the first message to identify the print job copy and the job ID (block 304). The retention system 110 operates to then store the print job copy in the job storage area 156 (block 306). In addition, the retention system 110 generates a job record (block 308). The job record indicates the present location of the print job copy (i.e., the job storage area 156). Additionally, the Job record includes the job ID.

The retention system 110 then stores the job record in the record storage area 158 (block 310).

Printing to the Retention Printer (Operational Scenario #2)

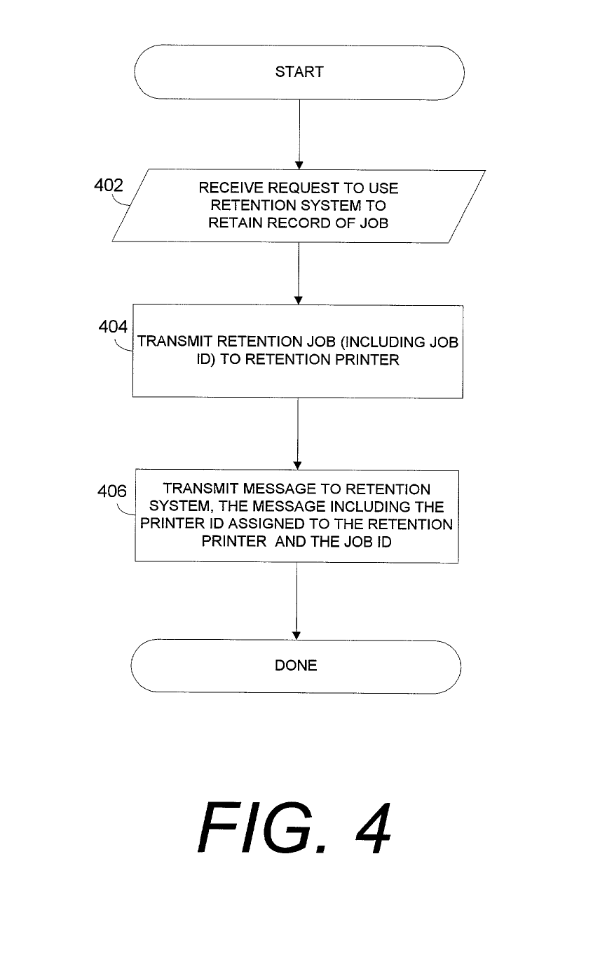

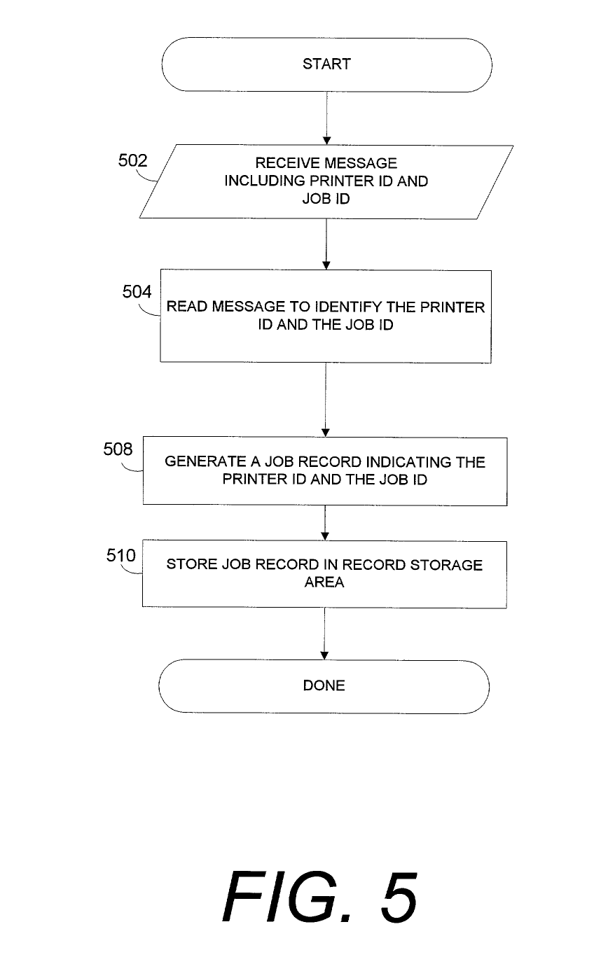

A user of the PC 104 can also make use of the retention system 110 to retain a record of certain retention jobs that are transmitted from the PC 104 to the retention printer 148. FIG. 4 and FIG. 5 illustrate this functionality.

FIG. 4 is a flow diagram illustrating the operation of the PC 104, under the direction of the document generation software 126, to transmit a print job assuming the following conditions exist. First, the print job is being transmitted to the retention printer 148. Secondly, the user enters a request to generate a record of the job. Thirdly, the print job will be retained by the retention printer 148 (i.e., the print job is a retention job). Fourthly, the print job being transmitted includes a job ID.

Turning now to FIG. 4, the PC 104 receives the request from the user to retain a record of the retention job (block 402). Next, the PC 104 transmits the retention job to the retention printer 148 (block 404). The retention job includes the assigned job ID.

The retention printer 148 receives and retains the retention job in the local disk drive 151. If the retention job is a quick copy job, for example, the retention printer 148 also prints it.

In response to the request received at block 402, the PC 104 transmits a second message to the retention system 110 (block 406). Importantly, the second message includes the printer ID assigned to the retention printer 148 and the job ID assigned to the retention job.

FIG. 5 illustrates the operation of the retention system 110, under the direction of the server application 154, upon receiving the second message. Turning now to FIG. 5, the retention system 110 receives the second message at block 502.

Next, the retention system 110 reads the second message to identify the printer ID and the job ID (block 504).

Next, the retention system 110 generates a job record of the retention job (block 508). The record indicates the printer ID of the retention printer 148 and the job ID. The record is then stored in the record storage area 158 (block 510).

Printing a Recorded Job

For ease of discussion, those print jobs that have a corresponding job record stored in the record storage area 158 may be referred to herein as a “recorded job”. It can be seen that a recorded job may be presently located in the job storage area 156 (see operational scenario #1). A recorded job may also be presently retained by the retention printer 148 (see operational scenario #2).

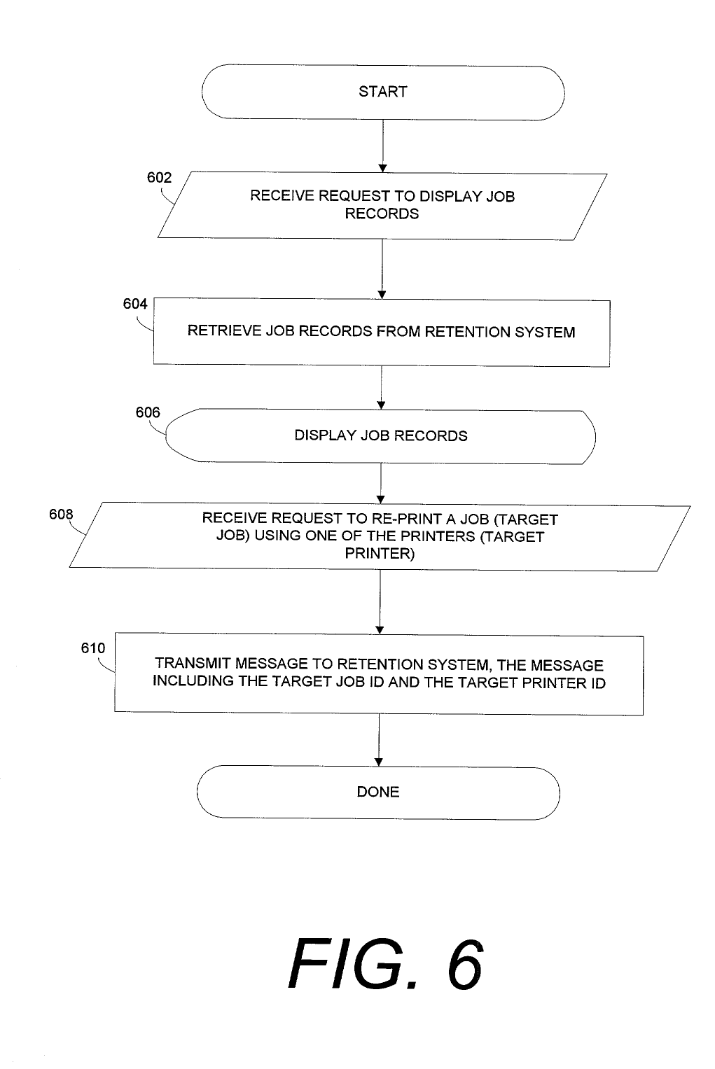

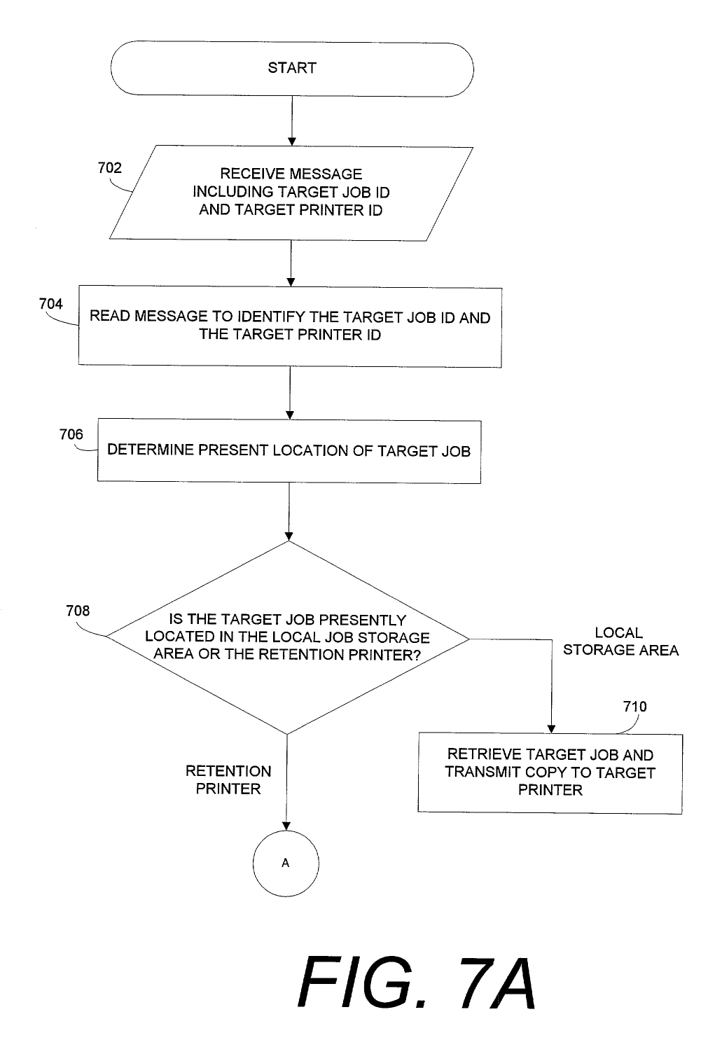

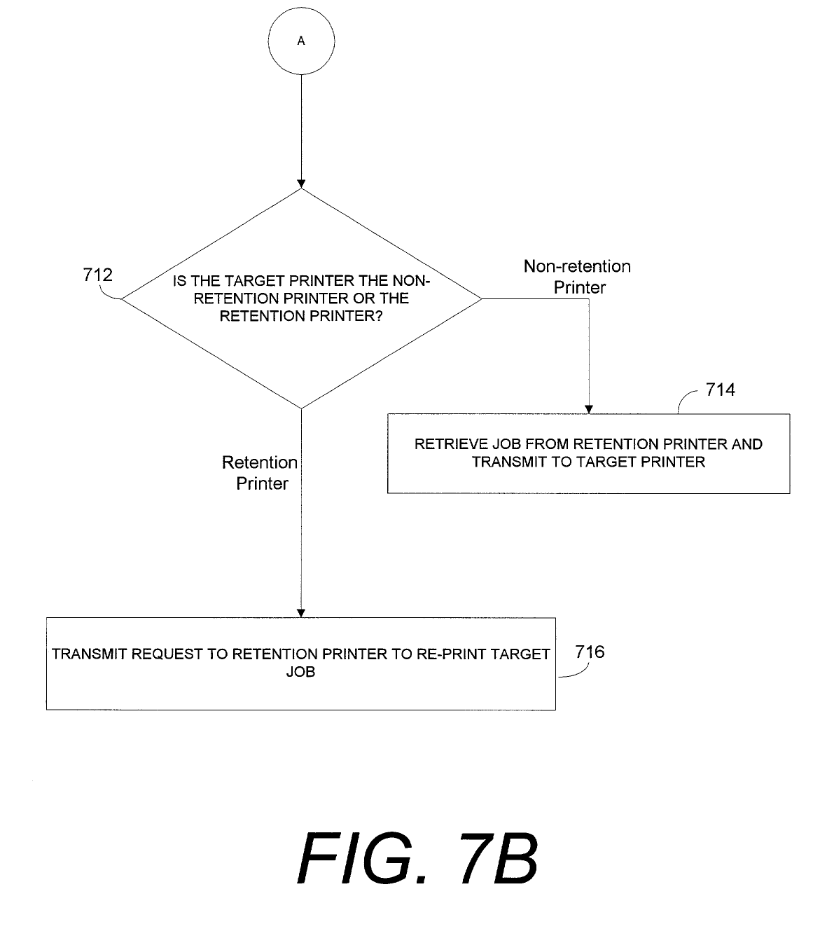

In general, a user of the PC 104 can make use of the re-print application 128 and the job retention system 110, to re-print a recorded job. FIG. 6 and FIG. 7 illustrate this functionality.

FIG. 6 is a flow diagram illustrating the operation of the PC 104, under the direction of the re-print application 128, to initiate the re-printing of a recorded job. Turning now to FIG. 6, the PC 104 receives a user request to display the job records that are presently stored in the job storage area 156. (block 602). In response to the request, the PC 104 retrieves these job records from the retention system 110 (block 604) and then displays them (block 606).

Next, the PC 104 receives a user request to re-print a recorded job using one of the printers in the printer group 106 (block 608). For ease of discussion, the recorded job to be re-printed will be referred to herein as the “target job”. The printer that is to be used to re-print the target job will be referred to herein as the “target printer”.

The request received at block 608 includes the job ID assigned to the target job (target job ID) and the printer ID (target printer ID) assigned to the target printer.

In response to the request received at block 608, the PC 104 transmits a third message to the retention system 110. The third message includes the target job ID and the target printer ID.

FIG. 7 is a flow diagram illustrating the operation of the retention system 110, under the direction of the server application 154, to receive and respond to the third message. Turning now to FIG. 7, the retention system 110 receives the third message (block 702). In response, the retention system 110 reads the third message to identify the target job ID and the target printer ID (block 704).

Next, the retention system 110 operates to determine the present location of the target job (block 706). This information may be obtained from the target job's corresponding job record stored in the record storage area 158.

The reader will note that the target job may be located in the job storage area 156 or may be presently retained by the retention printer 148. In addition, the target printer may be the non-retention printer 144 or the retention printer 148.

If the target job is located in the job storage area 156 (block 708), the retention system 110 operates to access the job storage area 156 to retrieve a copy of the target job. The copy of the target job is then transmitted to the target printer (block 710).

If, however, the target job is presently being retained by the retention printer 148 and the target printer is the non-retention printer 144 (block 712), then the retention system 110 operates to retrieve a copy of the target job from the retention printer 148 (block 714). The retention system 110 then transmits the target job to the non-retention printer 144.

If, however, the target job is presently being retained by the retention printer 148 and the target printer is also the retention printer 148, then the retention system 110 operates to transmit a request to the retention printer 148 (block 716). The request directs the retention printer 148 to re-print the target job.

From the foregoing, it can be seen that a printing system provided by the invention offers numerous advantages. For example, the system allows a user of a PC to retain and then re-print jobs that are sent to printers that do not support job retention. In addition, the printing system 102 allows the user to re-print a print job using any printer in a group of printers from a remote device without having to walk-up to a printer's control panel.

It is important to note, that in other embodiments, the computer that originally sent the target job and the computer that initiates the re-printing of the job may be two different computers. For example, it can be seen that the operation of the re-print application 128 may be performed by a personal digital assistant (PDA), a laptop computer, another personal computer or some other type of computing device.

In the embodiments just described, the functionality provided by any one of the programs described above may alternatively be provided in whole or in part by hardware components. For example, one or more of the steps illustrated in any of the flow diagrams could be performed by operation of an application specific integrated circuit having appropriate logic gates, a programmable gate array (s) (PGA) or a field programmable gate array (FPGA). Additionally, it should be understood that any of the steps depicted in the flow diagrams may be performed in a different sequence shown. In fact, some steps may be performed concurrently or with partial concurrence, in reverse order, etc.

It is important to note that in other embodiments of the invention, the computer that originally sent the target job and the computer that initiates the re-printing of the target job are two different computers. For example, it can be seen that the re-print operation of the PC 104 could be performed by a personal digital assistant (PDA) or a laptop computer. This would allow a user to re-print a global retention job without having to access the same computer that originally sent the job. This can be particularly advantageous in situations wherein the user does not have access to the PC 104. For example, in the embodiment just described the printers in the printer group 105 may be physically located anywhere in the world. The user may make use of the retention service 110 to re-print jobs at these physically dispersed locations.

It is also noted that in other embodiments, the user is provided the option of changing the way the target job will be printed by the target printer. For example, the user may be given the option to change the type of retention printing that will be used to print the target job, adjust the number of copies that will be printed, etc.

Furthermore, the present invention may be embodied in the form of a “computer readable medium” that has any one of the programs described above embodied therein. For example, the memory 124 and the memory 152 may each be considered embodiments of the invention. Importantly, the phrase “computer readable medium” can refer to any medium that can contain, store or propagate computer readable code. Thus, in this context, the phrase “computer readable medium” may refer to a random-access memory (RAM), read-only memory (ROM), a compact disk, magnetic tape, magnetic disk. The phrase “computer readable medium” may also refer to signals that are used to communicate a program over a network or the INTERNET. The phrase “computer readable medium” may also refer to a carrier wave.

Although specific embodiments of the invention have been described and illustrated, the invention is not to be limited to specific forms or arrangements of parts so described and illustrated. The invention is limited only be the claims.

What is claimed is:

1. A computer implemented method comprising:
(a) transmitting a print job to a first printer; and
(b) automatically transmitting a first message to a retention system, the first message including a copy of the print job; and wherein the retention system is responsive to the first message by storing the print job copy.

2. The method of claim 1, further comprising:
(c) transmitting a retention job to a retention printer; and
(d) automatically transmitting a second message to the retention system, the second message including an identifier assigned to the retention job and an identifier assigned to the retention printer; and wherein the retention system is responsive to the second message by storing a record of the retention job.

3. The method of claim 2, wherein the retention system is further responsive to receiving the first message by storing a record of the print job copy, the record including an identifier assigned to the print job copy.

4. The method of claim 3, further comprising:
(e) in response to user input, retrieving the record of the print job copy and the record of the retention job; and
(f) displaying at least some of the information included in the record of the print job copy and at least some of the information included in the record of the retention job.

5. The method of claim 4, further comprising:
(g) receiving a user request to print the print job copy using a second printer; and
(h) in response to the user request, transmitting a third message to the retention system, the third message including the identifier assigned to the print job copy; and wherein the retention system is responsive to the third message by transmitting a copy of the print job copy to the second printer.

6. The method of claim 2, further comprising:
(e) receiving a user request to print the retention job using a third printer; and
(f) in response to the user request, transmitting a third message to the retention system, the third message including the identifier assigned to the retention job and an identifier assigned to the third printer; and wherein the retention system is responsive to the third message by retrieving the retention job from the retention printer and then transmitting the retention job to the third printer.

7. The method of claim 2, wherein the retention system is a remote computing device coupled to the computer over a network.

8. A computer readable medium embodying a program of instructions executable by the computer to perform method steps, the method steps comprising:
(a) transmitting a print job to a printer; and
(b) automatically causing a remote computing device to store a copy of the print job.

9. The computer readable medium of claim 8, wherein the printer is a non-retention printer.

10. The computer readable medium of claim 9, wherein the method steps further comprising:
(c) transmitting a second print job to a second printer; the second printer responsive to the print job by retaining the print job; and
(d) automatically causing the remote computing device to store a record of the second print job, the record including an identifier assigned to the second print job and an identifier assigned to the second printer.

11. The computer readable medium of claim 10, wherein step (b) further includes causing the remote computing device to store a record of the copy of the print job.

12. The computer readable medium of claim 11, wherein the method steps further comprising:
(e) in response to user input, retrieving the record of the print job copy and the record of the print job from the remote computing device; and
(f) displaying the record of the print job copy and the record of the print job.

13. The computer readable medium of claim 8, wherein the method steps further comprising:
(c) receiving a request to print the print the print job copy using a third printer; and
(d) responding to the request by causing the remote computing device to transmit the print copy to the third printer.

14. A system, comprising:
(a) a retention system; and
(b) a first computer operable by a user to transmit a first print job to a first printer and to automatically transmit a first message to the retention system, the message including a copy of the first print job; and wherein the retention system is responsive to receiving the message by storing the copy of the first print job.

15. The system of claim 14, further comprising:
(c) a second computer operable by a user to transmit a command to the retention system, the command including an identifier assigned to the first print job and an identifier assigned to a second printer; and wherein the retention system is responsive to the command by transmitting the copy of the first print job to the second printer.

16. The system of claim 15, wherein the first computer and the second computer are two different computers.

17. The system of claim 16, wherein the first computer is operable by a user to transmit the command.

18. The system of claim 17, wherein the first printer and the second printer are two different printers.

19. The system of claim 18, wherein the first computer is further operable by a user to transmit a retention job to a retention printer and to automatically transmit a second message to the retention system, the second message including a first identifier assigned to the retention job and a second identifier assigned to the retention printer; and wherein the retention system is responsive to the second message by creating and then storing a retrievable record of the retention job in a memory.

20. The system of claim 18, wherein the retention system is a computing device coupled to the first computer over the INTERNET.
